(19) United States
(12) Patent Application Publication
(10) Pub. No.: US 2007/0175945 A1
(43) Pub. Date: Aug. 2, 2007

(54) Cylinder structure for pneumatic tools

(75) Inventors: Jack Chen, Taichung City (TW); Jim Wang, Taichung City (TW)

Correspondence Address: EGBERT LAW OFFICES, 412 MAIN STREET, 7TH FLOOR, HOUSTON, TX, 77002, US

(73) Assignee: BASSO INDUSTRY Corp., Taichung City (TW)

(21) Appl. No.: 11/340,059

(22) Filed: Jan. 27, 2006

(51) Int. Cl. B25C 1/04

(52) U.S. Cl. 227/130

(57) ABSTRACT

The cylinder structure for a pneumatic tool includes a first and second cylinder placed inside the pneumatic tool, and a first and second piston placed inside the first and second cylinder. The one-piece structure of the first and second cylinder are inside the pneumatic tool, and the air inlet of the first cylinder and the air inlet of the second cylinder can be connected by a first bypass. The lower air chamber of the first cylinder is connected to the second piston of the second cylinder at the bottom by a second bypass. The double cylinder of the pneumatic tool avoids being hit by external forces, which extends the life of usage. The invention makes the manufacturing process simpler and more effective, and the end product looks more unified.

### RELATED U.S. APPLICATIONS

Not applicable.

### STATEMENT REGARDING FEDERALLY SPONSORED RESEARCH OR DEVELOPMENT

Not applicable.

### REFERENCE TO MICROFICHE APPENDIX

Not applicable.

### FIELD OF THE INVENTION

The present invention relates generally to a pneumatic tool, and more particularly to a pneumatic tool that has a cylinder structure.

### BACKGROUND OF THE INVENTION

The conventional pneumatic nail gun uses a single cylinder and piston to achieve the nailing function.

Some nail guns have other functions besides a nailing function, such as sending the pad to the nail outlet when nailing. Thus, after the nail is sent, the gun has the extra effect of padding, which satisfies multiple needs of the user. To implement this function, the industry usually adds a second cylinder and piston on one side of the original cylinder (hereafter referred to as the first cylinder) to drive the component of the other function mentioned above. Moreover, it creates an air channel between the second cylinder and the first cylinder so that the piston inside the second cylinder can be displaced while the first cylinder is nailing.

The conventional structure of the second cylinder and the first cylinder is shown in FIG. 1, which has the second cylinder 20 added on one side of the external side of the first cylinder 01. The first cylinder 01 and the second cylinder 02 are connected by an external channel. It is found that the conventional structure is easy to displace due to the external force when using the second cylinder 03 and its pipe 04, which damages the connecting part and creates leakage. Therefore, it is easily broken and its life of usage is shortened as well. In terms of the manufacturing, the first cylinder 01, the second cylinder 02 and the pipe 04 are loose components. Thus, it takes an assembling process to make the product, which is time consuming and lacks of efficiency. In terms of product design, it affects the entire look and unity, which is a subject that needs to be improved further.

Thus, to overcome the aforementioned problems of the prior art, it would be an advancement in the art to provide an improved structure that can significantly improve the efficacy.

To this end, the inventor has provided the present invention of practicability after deliberate design and evaluation based on years of experience in the production, development and design of related products.

### BRIEF SUMMARY OF THE INVENTION

The structure disclosed in the present invention primarily comprises a one-piece structure of the first cylinder 10 and the second cylinder 20 inside the pneumatic tool A. As compared to the conventional structure previously mentioned, the double cylinder of the pneumatic tool can achieve the following advantages:
1. To place the first and second cylinder 10 20 inside the pneumatic tool to avoid being hit by external forces, which extends its life of usage;
2. To make the assembling process simpler, shortening the hours of labor to reducing the cost to meet the preferred industrial practicability; and
3. To make the product have better looks and have higher quality.

Moreover, the air channel between the first cylinder and second cylinder 20 can be achieved by the first bypass 22 and the second bypass 24 without assembling external pipe. Therefore, it makes the manufacturing simpler, and has better looks and unity.

Although the invention has been explained in relation to its preferred embodiment, it is to be understood that many other possible modifications and variations can be made without departing from the spirit and scope of the invention as hereinafter claimed.

### BRIEF DESCRIPTION OF THE SEVERAL VIEWS OF THE DRAWINGS

FIG. 1 shows a perspective view of the conventional structure.

FIGS. 2-3 show sectional views of the preferred embodiment of the present invention.

FIG. 4 shows a vertical sectional view of the cylinder structure after removing the piston of the preferred embodiment of the present invention.

FIG. 5 shows a horizontal sectional view of the cylinder structure of the preferred embodiment of the present invention.

FIG. 6 shows an isolated sectional view of the operation of the second piston of the present invention being restored by the spring.

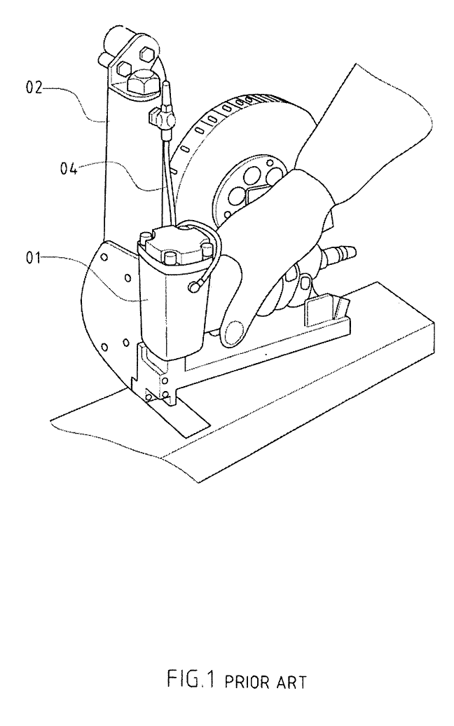

### DETAILED DESCRIPTION OF THE INVENTION

The features and the advantages of the present invention will be more readily understood upon a thoughtful deliberation of the following detailed description of a preferred embodiment of the present invention with reference to the accompanying drawings.

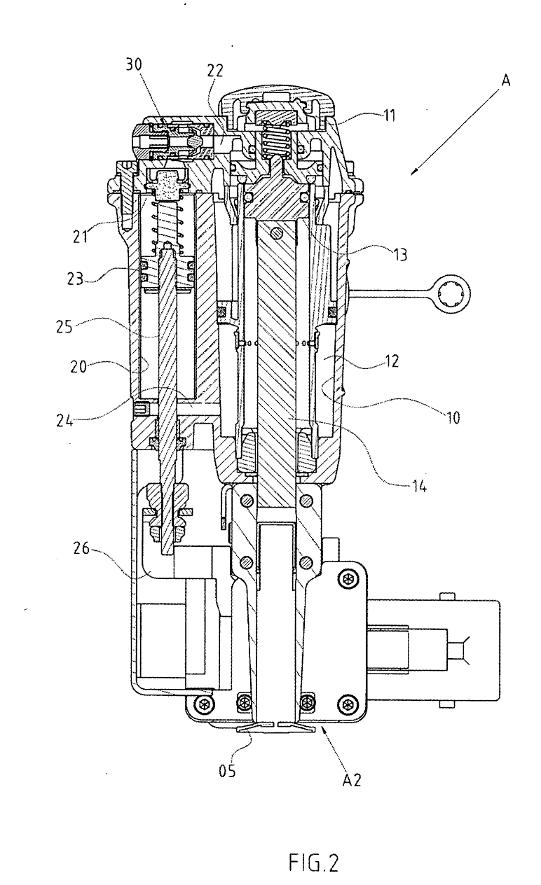

As shown in FIGS. 2-4, there is a preferred embodiment of a cylinder structure for pneumatic tools, wherein the pneumatic tool A is a nailer.

A first cylinder 10 is placed inside the pneumatic tool A, and the first cylinder 10 includes an air inlet 11 and a lower air chamber 12 (the present embodiment is the through hole style that is placed on the wall of the first cylinder). A first piston 13 is placed inside the first cylinder 10, and in the present embodiment, the first piston 13 drives the striker pin 14 to make the expected nailing movement.

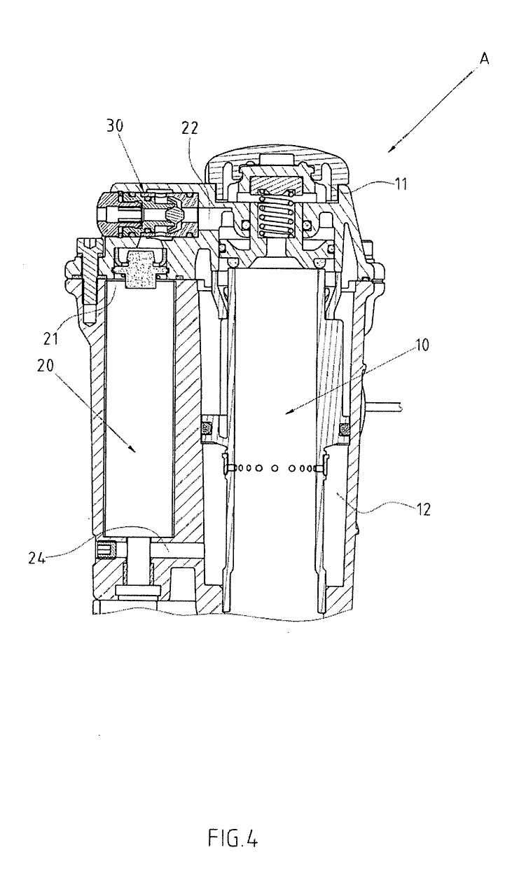

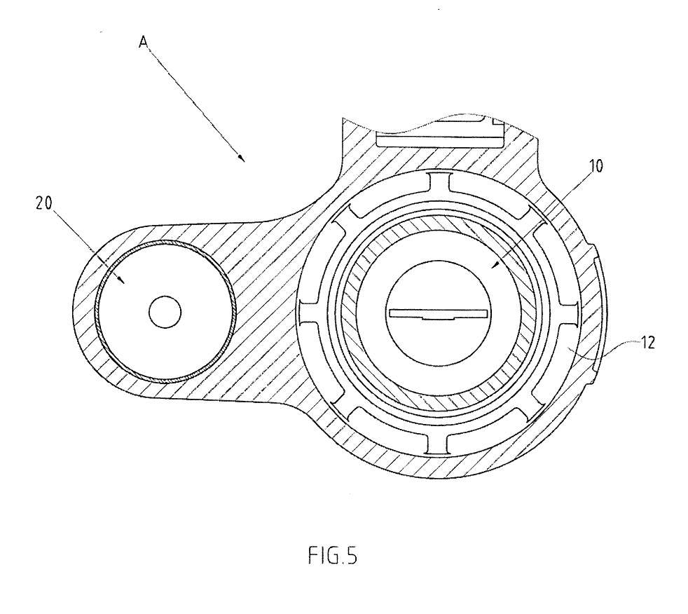

A second cylinder 20 is a supply cylinder, and it is placed on one side of the first cylinder 10 inside the pneumatic tool A (as shown in FIG. 4). The second cylinder is placed at an interval from the first cylinder. The air inlet 21 of the second cylinder 20 is connected to the air inlet 11 for the first bypass 22 and the first cylinder 10. A second piston 23 is placed inside the second cylinder 20, and at the bottom of the second piston 23, the second cylinder 20 is connected to the lower chamber 12 of the first cylinder 10 by a second bypass 24. The second piston 23 drives a driving shaft 25.

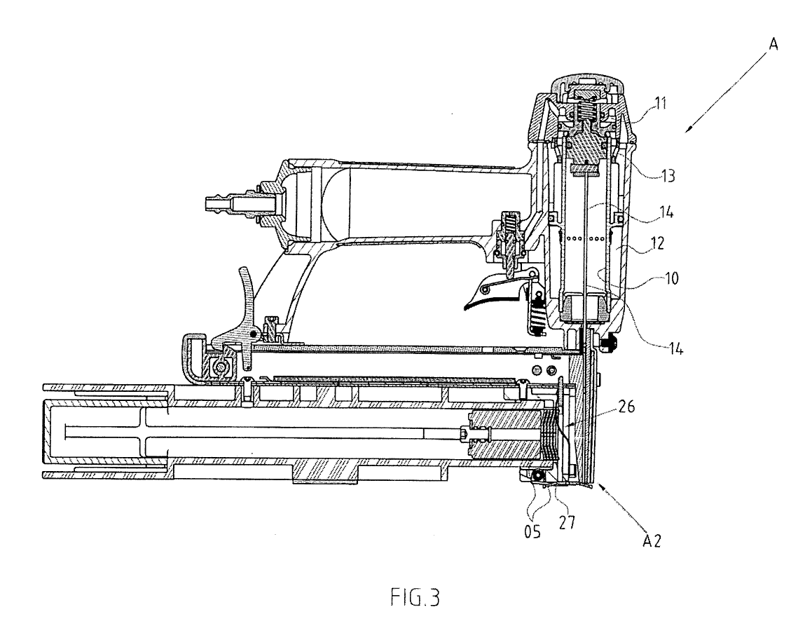

When it is connected to the air pressure, the air inlet 11 of the first cylinder is full of compressed air, and it enters the second cylinder 10 from the first bypass 22 to drive the second piston 23. The second piston 23 drives the driving shaft 25 downward, and the driving shaft is operated, as shown in FIG. 3 in the present embodiment, downward to drive a shelf 26. The movement of the shelf can control the disc 05 in the direction of the nail outlet A2, and when the disc 05 moves to the nail outlet A2 of the pneumatic tool A, it uses an elastic press plate 27 to press to position.

When driving the pneumatic tool A, the first piston 13 inside the first cylinder 10 is driven downward to move the striker pin 14. When the nail is stroked out, the disc 05 can be stroked in synchronized movement to achieve the purpose of supplying. At this time, the pressure of the air inlet 11 of the first cylinder is lower and cannot continue to supply the second cylinder 20, which causes the lower air pressure on top of the second piston. At the same time, the air of the lower air chamber 12 of the first cylinder 10 is sent to the second cylinder 10 by the second by pass 24. The air pressure of the second bypass 24 is higher than the air pressure on top of the second piston 23; therefore, the second piston 23 is pushed back to the starting point from the bottom.

Among them, a reverse valve can be placed on the first bypass 22 between the air inlet 11 21 of the first and second cylinder 10 20, controlling the inlet and outlet paths of the second cylinder 20. As for the structure of the reverse valve, it can be all different types, which is not what this case trying to define, therefore, it is not described in detail.

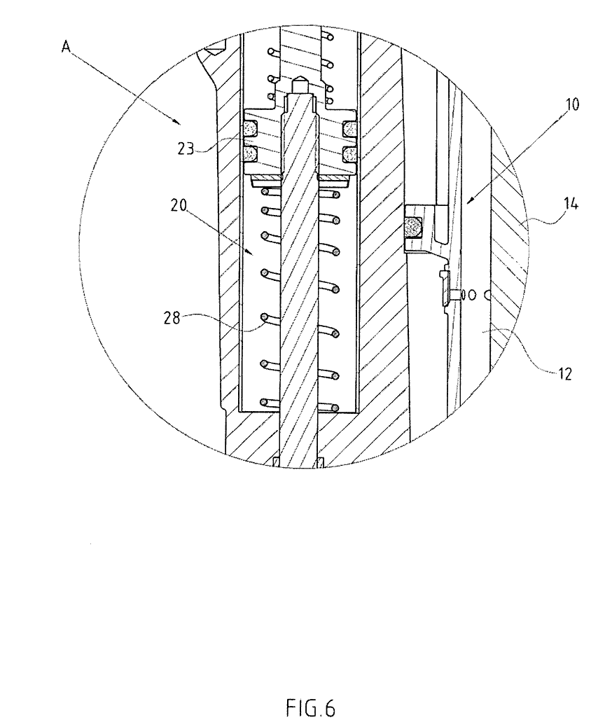

The second piston 23 of the second cylinder 20 can also be connected without using the second bypass 24 for air pressure. As shown in FIG. 6, a spring 28 is placed on the bottom of the second piston 23, which accumulated elasticity is resumed when the second piston 23 is slipped downward. By so doing, when the air pressure is lower at top of the second piston 23, it uses the elasticity of the spring 28 to push the second piston 23 upward.

We claim:

1. A cylinder structure for a pneumatic tool, said cylinder structure comprising:
a first cylinder having an air inlet;
a second cylinder, placed inside the pneumatic tool with the first cylinder, and placed at an interval from the first cylinder inside the pneumatic tool, said second cylinder having an air inlet placed inside the second cylinder; and
a first bypass connecting the air inlet of the first cylinder and the air inlet of the second cylinder.

2. The cylinder structure defined in claim 1, wherein said second cylinder is a supply cylinder.

3. The cylinder structure defined in claim 2, wherein a supply material of said supply cylinder is pads.

4. The cylinder structure defined in claim 2, further comprising:
a reverse valve placed on the first bypass between the air inlets of the first and second cylinder.

5. The cylinder structure defined in claim 1, further comprising:
a second bypass placed on a bottom of the second cylinder and the first cylinder.

6. A cylinder structure for a pneumatic tool, said cylinder structure comprising:
a first cylinder; and
a second cylinder formed in one piece inside the pneumatic tool, said first cylinder and said second cylinder being placed at an interval.

7. The cylinder structure defined in claim 6, wherein said second cylinder is a supply cylinder.

8. The cylinder structure defined in claim 7, wherein a supply material of said supply cylinder is pads.

9. The cylinder structure defined in claim 6, wherein said first cylinder has an air inlet and a lower air chamber, said cylinder structure further comprising:
a first piston placed inside the first cylinder; and
a second piston placed inside the second cylinder.

10. The cylinder structure defined in claim 9, further comprising:
a restoring spring placed on a bottom of the second piston of the second cylinder.

11. The cylinder structure defined in claim 9, further comprising:
an air inlet of the second cylinder connected to the air inlet of the first cylinder by a first bypass, said second cylinder being connected to a lower air chamber of the first cylinder by placing a second bypass at the bottom of the second piston.

12. The cylinder structure defined in claim 1 1, further comprising:
a reverse valve placed on the first bypass.
